(19) United States
(12) Patent Application Publication
(10) Pub. No.: US 2010/0284356 A1
(43) Pub. Date: Nov. 11, 2010

(54) COMMUNICATION OF INFORMATION ON BUNDLING OF PACKETS IN A TELECOMMUNICATION SYSTEM

(75) Inventors: Siddharth Ray, San Diego, CA (US); Ashwin Sampath, Bridgewater, NJ (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/773,363

(22) Filed: May 4, 2010

Related U.S. Application Data
(60) Provisional application No. 61/176,043, filed on May 6, 2009.

(51) Int. Cl. H04W 40/00; H04W 72/04

(52) U.S. Cl. 370/329; 370/328

(57) ABSTRACT

Systems and methods are described to communicate information that specifies bundling of packets and to respond to the bundling in a wireless communication environment. A user equipment (UE) performs bundling of data packets without reliance on a radio resource grant. The UE can generate a bundling report comprising information that specifies at least in part the bundling and transmits the bundling report to a base station. The information can convey a number of bundled data packets; a number of unbundled data packets at the user equipment; an amount of bundled data at the mobile device; or a combination thereof. The UE can transmit the bundling report in accordance with a preconfigured delivery mode or can receive from the base station an indication of a delivery mode to transmit the bundling report. The base station can utilize the information conveyed in the bundling report to schedule radio resource(s).

### CROSS-REFERENCE TO RELATED APPLICATION

This application claims the benefit of U.S. Provisional Patent Application Ser. No. 61/176,043 entitled “METHOD AND APPARATUS TO ENABLE COMMUNICATION OF AMOUNT OF BUNDLED DATA FROM THE MOBILE TO THE BASE STATION IN A CELLULAR WIRELESS SYSTEM” which was filed May 6, 2009. The entirety of the aforementioned application is herein incorporated by reference.

### BACKGROUND

I. Field

The following description relates generally to wireless communications and, more particularly, to communication of information that specifies data packet bundling and responses to the communication of such information in a telecommunication system.

II. Relevant Background

Wireless communication systems are widely deployed to provide various types of communication content such as, for example, voice, data, and so on. Typical wireless communication systems can be multiple-access systems capable of supporting communication with multiple users by sharing available system resources (e.g., bandwidth, transmit power . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), multi-carrier wireless specifications such as evolution data optimized (EV-DO), one or more revisions thereof, etc.

Generally, wireless multiple-access communication systems can simultaneously support communication for multiple user equipments (UEs). Each UE can communicate with one or more base stations via transmissions on wireless links, e.g., uplink or downlink, in the air-interface. The downlink (DL) refers to the telecommunication link from base stations to UEs, and the uplink (UL) refers to the telecommunication link from UEs to base stations. Further, communications between UEs and base stations can be established via single-input single-output (SISO) systems, multiple-input single-output (MISO), multiple-input multiple-output (MIMO) systems, and so forth. In addition, UEs can communicate with other UEs (and/or base stations with other base stations) in peer-to-peer wireless network configurations.

Various types of base stations can communicate with a UE. Each of the various types of base stations can be associated with differing cell sizes. For instance, macro cell base stations typically leverage antenna(s) installed on masts, rooftops, other existing structures, or the like. Further, macro cell base stations oftentimes have power outputs on the order of tens of watts, and can provide coverage for large areas. The femto cell base station is another class of base station that has recently emerged. Femto cell base stations are commonly designed for residential or small business environments, and can provide wireless coverage to UEs using a wireless technology (e.g., 3GPP Universal Mobile Telecommunications System (UMTS) or LTE, 1× Evolution-Data Optimized (1×EV-DO), . . . ) to communicate with the UEs and an existing broadband Internet connection (e.g., digital subscriber line (DSL), cable, . . . ) for backhaul. A femto cell base station can also be referred to as a Home Evolved Node B (HeNB), a Home Node B (HNB), a femto cell, an access point base station, or the like. Examples of other types of base stations include pico cell base stations, micro cell base stations, and so forth.

Regardless of the type of base station, in contemporaneous wireless communication systems, data traffic is communicated mainly as a stream of packets, either data packets or control packets. Advances of radio technology provide with increased data rate and even though substantively richer applications are enabled in commonplace UEs, complexity of data processing in such UEs poses several design and implementation challenges with respect to processing and management of large amounts of packetized data. In addition, constraints in spectral bandwidth also pose a challenge in connection with maintaining the volume of data (e.g., encoded bits) to a level that allows efficient operation of the UEs and a satisfactory or superior perceived quality of service. Conventional wireless communication systems exploit mechanisms that reduce volume, or amount, of bits that are delivered in the uplink (UL); for example, in cellular wireless networks, concatenation and compression of data packets increases efficiency of communication.

However, in conventional wireless communication systems, the efficiency is limited because the mechanisms for compression and concatenation depend on allocation of radio resources in the UL, and since data traffic (e.g., images collected through a call session with video streaming such as a videoconference) that is available for delivery in a UE is stochastic, a scheduler in a base station that serves the UE has to estimate size of resource grants and allocate those grants in order to enable concatenation and compression. Thus, conventional systems typically misallocate air resources in the UL which degrades performance of concatenation and compression with the ensuing degradation in communication efficiency.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Various aspects are described in connection with information that specifies bundling of data packets and response to the bundling in a wireless communication system. User equipment (UE) performs bundling of data packets without reliance on allocation of radio resource grant(s). The UE can generate a bundling report comprising information that specifies at least in part the bundling and transmits the bundling report to a base station. The information can convey a number of bundled data packets at the UE; a number of unbundled data packets at the user equipment; an amount of bundled data at the UE; or a combination thereof. The UE can transmit the bundling report in accordance with a preconfigured (e.g., standardized) delivery mode. Additionally or alternatively, the UE can receive from the base station an indication of a delivery mode to transmit the bundling report. The base station can utilize the information conveyed in the bundling report to schedule radio resource(s).

While illustrated for cellular wireless systems, the aspects of the subject disclosure are not so limited and can be exploited in most any communication system, wireless or otherwise, that utilizes packetized data streams and relies on managed (e.g., scheduled) allocation of communication resources (bandwidth, transmit time, etc.). In addition, for a wireless communication system, the various aspects described herein can be exploited irrespective of particular radio technologies employed for telecommunication.

In an aspect described herein, a method is disclosed. The method includes performing bundling of a set of data packets at a user equipment; generating a report comprising information that specifies at least in part the bundling in response to performing the bundling; and conveying the report to a base station from the user equipment.

In a related aspect, an apparatus is described herein. The apparatus includes at least a memory that retains instructions related to performing bundling of a set of data packets at a user equipment, generating a report comprising information that specifies at least in part the bundling in response to performing the bundling and conveying the report to a base station from the user equipment. In addition, the apparatus includes at least a processor functionally coupled to at least the memory and configured to execute the instructions.

A wireless communication apparatus is described in another related aspect. The wireless communication apparatus includes means for performing bundling of a set of data packets at a user equipment; means for generating a report comprising information that specifies at least in part the bundling in response to performing the bundling; and means for conveying the report to a base station from the user equipment.

In yet another aspect, a computer program product is disclosed. The computer program product includes a computer-readable medium, which can include code for causing at least one computer to perform bundling of a set of data packets at a user equipment; code for causing the at least one computer to generate a report comprising information that specifies at least in part the bundling in response to performing the bundling; and code for causing the at least one computer to convey the report to a base station from the user equipment.

Still another aspect disclosed herein relates to a wireless communication apparatus that can include at least a processor configured to perform bundling of a set of data packets at a user equipment. In addition, at least the processor can be configured to generate a report comprising information that specifies at least in part the bundling in response to performing the bundling, the information conveys at least one of a number of bundled data packets at the user equipment; an amount of bundled data at the user equipment, the bundled data resulting from performing the bundling; or a combination thereof. Moreover, at least the processor can be configured to transmit the report to a base station from the user equipment.

In accordance with other aspects, a method is described herein. The method includes receiving from a mobile device a total amount of data per logical channel index (LCID) at the mobile device; receiving from the mobile device a report that specifies at least in part bundling of a set of data packets, the mobile device performing the bundling; and scheduling one or more radio resources in response to at least one of the total amount of data per LCID and the report.

In related aspects, an apparatus is disclosed. The apparatus can include at least a memory that retains instructions related to receiving from a mobile device a report that specifies at least in part bundling of a set of data packets, the mobile device performing the bundling, and scheduling one or more radio resources in response to at least the report. The apparatus also includes at least a processor functionally coupled to at least the memory and configured to execute the instructions retained in at least the memory.

In additional related aspects, a wireless communication apparatus is disclosed. The wireless communications apparatus includes means for receiving from a mobile device a total amount of data per logical channel index (LCID) at the mobile device; means for receiving from the mobile device a report that specifies at least in part bundling of a set of data packets; and means for scheduling one or more radio resources in response to at least one of the total amount of data per LCID and the report.

A computer program product is disclosed in further related aspects. The computer program product includes, a computer-readable medium, which can include code for causing at least one computer to receive from a mobile device a report that specifies at least in part bundling of a set of data packets performed at the mobile device; and code for causing the at least one computer to schedule one or more radio resources in response to at least on the report.

In still further related aspects, a wireless communication apparatus is described. The wireless communication apparatus can include at least a processor configured to receive from a mobile device a total amount of data per logical channel index (LCID) at the mobile device. In addition, at least the processor can be configured to receive from the mobile device a report that specifies at least in part bundling of a set of data packets, the mobile device performing the bundling. Moreover, at least the processor can be configured to schedule one or more radio resources in response to at least one of the total amount of data per LCID and the report.

At least an advantage of the aspects described herein is the reduction of complexity of packet processing at the UE, since bundling of packets (data packets or control packets) can be effected without reliance on allocation of radio resource grants. At least another advantage is the enhancement of UL radio resource allocation afforded at least in part through the information in the bundling report, which conveys features of the bundling of packets (data packets or control packets) performed at the UE and the ensuing knowledge of volume of data that the UE can transmit in the UL.

Toward the accomplishment of the foregoing and related ends, the one or more embodiments comprise the features hereinafter fully described and particularly pointed out in the claims. The following description and the annexed drawings set forth herein detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 illustrates a wireless communication system in accordance with various aspects set forth herein.

FIG. 2 is a diagram that illustrates bundling of data packets and reporting thereof in accordance with aspects of the subject disclosure.

FIG. 3 illustrates an example system that enables and exploits bundling of data packets and reporting thereof in a wireless communication system in accordance with aspects of the subject disclosure.

FIG. 4 presents an example embodiment of user equipment that enables and exploits bundling and reporting thereof in a wireless communication system in accordance with aspects described herein.

FIG. 5 presents an example embodiment of a base station that enables and exploits bundling and reporting thereof in a wireless communication system in accordance with aspects described herein.

FIG. 6 presents a flowchart of an example method for communicating one or more characteristics of bundling of data packets in accordance with aspects described herein.

FIG. 7 presents a flowchart of an example method for conveying a report that characterizes bundling performed to a set of data packets in accordance with aspects described herein.

FIG. 8 is a flowchart of an example method for responding to information that specifies bundling of data packets in a wireless communication system in accordance with aspects disclosed herein.

FIG. 9 is a flowchart of an example method for configuring a delivery mode to provide a report comprising information that specifies bundling of a set of data packets in a wireless communication system in accordance with aspects described herein.

FIGS. 10-11 present example systems that enable bundling of data packets and reporting thereof in a wireless communication system in accordance with aspects described herein.

FIGS. 12-13 illustrate example systems that can be utilized to implement various aspects of the functionality described herein.

FIGS. 14-15 illustrate example wireless communication systems that can be employed in conjunction with the various systems and methods described herein.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer-readable storage media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Various techniques described herein can be used for various wireless communication systems, such as code division multiple access (CDMA) systems, time division multiple access (TDMA) systems, frequency division multiple access (FDMA) systems, orthogonal frequency division multiple access (OFDMA) systems, single carrier-frequency division multiple access (SC-FDMA) systems, and other such systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95, and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits UEs in terms of transmit power efficiency. Accordingly, SC-FDMA can be implemented as an uplink multiple access scheme in 3GPP Long Term Evolution (LTE) or Evolved UTRA (E-UTRA).

Furthermore, various aspects are described herein in connection with user equipment (UE). A UE can refer to a device providing voice and/or data connectivity. A UE can be connected to a computing device such as a laptop computer or desktop computer, or it can be a self-contained device such as a personal digital assistant (PDA). A UE can also be called a system, subscriber unit, subscriber station, mobile station, mobile device, remote station, remote terminal, user terminal, terminal, wireless communication device, user agent, user device, or access terminal. A UE can be a cellular telephone, a cordless telephone, a Session Initiation Protocol (SIP) phone, a wireless local loop (WLL) station, a PDA, a handheld device having wireless connection capability, computing device, or other processing device connected to a wireless modem. Moreover, various aspects are described herein in connection with a base station. A base station can be utilized for communicating with UE(s) and also can be referred to as an access point, Node B, Evolved Node B (eNodeB, eNB) or some other terminology. A base station can refer to a device in an access network that communicates over the air interface, through one or more sectors, with UEs. The base station can act as a router between the wireless terminal and the rest of the access network, which can include an Internet Protocol (IP) network, by converting received air interface frames to IP packets. The base station can also coordinate management of attributes for the air interface.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as employed in this application and the appended claims should generally be construed to mean “one or more” unless specified otherwise or clear from the context to be directed to a singular form. Furthermore, in the subject disclosure, the term “set” is intended to refer to groups of one or more entities; for example, a set of data packets refers to one or more data packets. However, as employed herein, the term “subset” can include the empty set unless otherwise noted, as in cases in which, for instance, disclosure of a subset of one or more entities is intended to avoid the empty subset.

Moreover, various functions described herein can be implemented in hardware, software, firmware, or any combination thereof. If implemented in software, the functions can be stored on or transmitted over as one or more instructions or code on a computer-readable medium. Computer-readable media includes both computer-readable storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various aspects will be presented in terms of systems that can include a number of devices, components, modules, and the like. It is to be understood and appreciated that the various systems can include additional devices, components, modules, etc. and/or one or more of the devices, components, modules, etc. discussed in connection with the figures need not be included. A combination of these approaches can also be used.

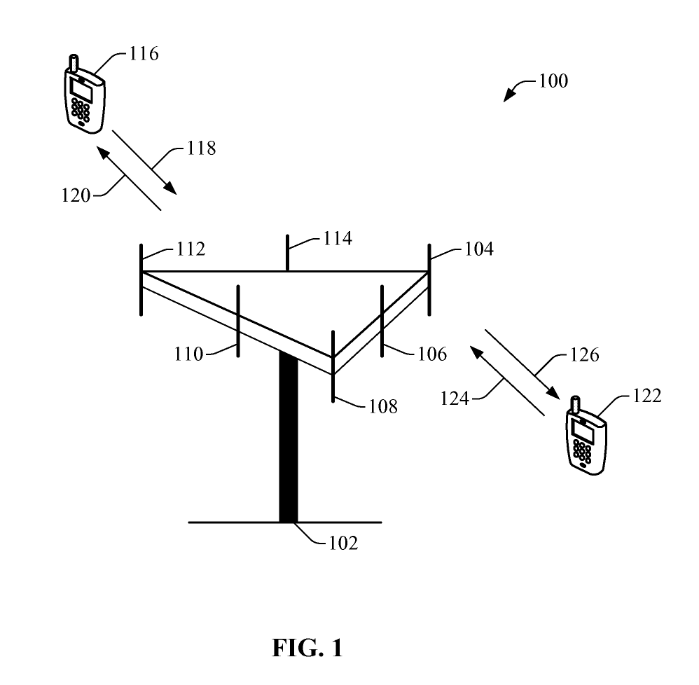

Referring now to FIG. 1, a system 100 is illustrated in accordance with various aspects presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (processors, modulators, multiplexers, demodulators, demultiplexers, antennas, etc.), as will be appreciated by one skilled in the art.

Base station 102 can communicate with one or more user equipments (UEs) such as UE 116 and UE 122; however, it is to be appreciated that base station 102 can communicate with substantially any number of UEs similar to UE 116 and UE 122. Communication amongst base station 102 and the one or more UEs can include bundling of packets (data packets or control packets) and reporting thereof in accordance with various aspects described hereinafter. UE 116 and UE 122 can be, for example, cellular phones, smart phones, laptops, handheld communication devices, handheld computing devices, satellite radios, global positioning systems, PDAs, and/or any other suitable device for communicating over system 100. As depicted, UE 116 is in communication with antennas 112 and 114, where antennas 112 and 114 transmit information to UE 116 over a downlink 120 and receive information from UE 116 over a downlink 120. Moreover, UE 122 is in communication with antennas 104 and 106, where antennas 104 and 106 transmit information to UE 122 over an uplink 124 and receive information from UE 122 over a downlink 126. In a frequency division duplex (FDD) system, uplink 118 can utilize a different frequency band than that utilized by downlink 120, and uplink 124 can employ a different frequency band than that employed by downlink 126, for example. Further, in a time division duplex (TDD) system, uplink 118 and downlink 120 can utilize a common frequency band and uplink 124 and downlink 126 can utilize a common frequency band.

Each group of antennas or the area in which they are designated to communicate can be referred to as a sector of base station 102. For example, antenna groups can be designed to communicate to UEs in a sector of the areas covered by base station 102. In communication over uplink 118 and uplink 124, the transmitting antennas of base station 102 can utilize beamforming to improve signal-to-noise ratio of uplink 118 and uplink 124 for UE 116 and UE 122. Also, while base station 102 utilizes beamforming to transmit to UE 116 and UE 122 scattered randomly through an associated coverage, UEs in neighboring cells can be subject to less interference as compared to a base station transmitting through a single antenna to all its UEs.

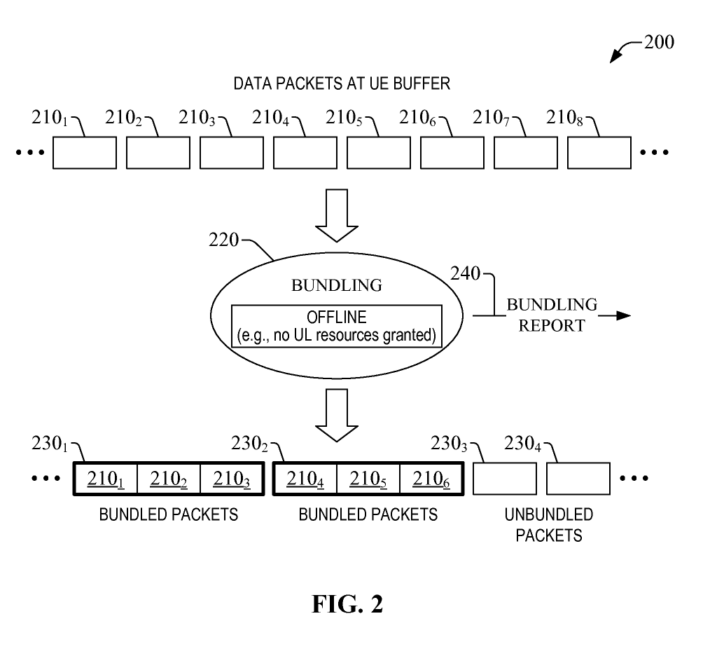

FIG. 2 is a diagram 200 that illustrates bundling of data packets and reporting thereof in a wireless communication system. Bundling of control packets and related reporting can be effected in a substantially the same manner. A first set of data packets, e.g., data packets 210₁-210₈, in a buffer within a UE (not shown) are concatenated at a bundling stage 220. In contrast to conventional wireless communication systems, such concatenation is performed without a radio resource grant allocated to the UE. Such concatenation of the first set of data packets 210₁-210₈ at the bundling stage 220 results in a second set of data packets, e.g., data packets 230₁-230₄, that is less complex (e.g., smaller) than the first set of data packets. Such concatenation is termed herein bundling of the first set of data packets. Bundling stage 220 is performed automatically or autonomously and offline—the concatenation is carried out without reliance on allocation of radio resources or control signaling received from a serving base station (not shown). In addition, bundling stage 220 can be implemented irrespective of the specific format of data packets in the first set of data packets. In addition, the UE can perform the bundling stage 220 at the Packet Data Convergence Protocol (PDCP) layer or the Radio Link Control (RLC) layer (e.g., at the Medium Access Control (MAC) layer. Since data packets arrive at the UE dynamically, e.g., in bursts that are stochastic, the UE performs the bundling opportunistically and thus a subset of the first set of data packets may remain unbundled in buffer within the UE in scenarios in which the UE has no opportunity for bundling two or more buffered data packets (e.g., 210₇ and 210₈); it should be appreciated that the subset can be empty or can include one or more data packets.

Performance of bundling stage 220 includes delivery of a bundling report 240 that comprises information that conveys various aspects of the bundling of the first set of data packets. In an embodiment, bundling report 240 includes information that conveys a number (N) of bundled data packets. In one or more instances in the subject disclosure, such information is referred to hereinafter as report payload type I. In another embodiment, bundling report 240 includes information that conveys the number (N) of bundled data packets (or bundles) and a number (M) of unbundled data packets at the mobile device; where N and M are integer numbers greater than or equal to zero. In such embodiment, the sum of N and M can equal the size of the buffer at the UE that performs the bundling. In one or more instances in the subject disclosure, such information is referred to hereinafter as report payload type II. In yet another embodiment, bundling report 240 includes information that conveys an amount of bundled data at the mobile device. In one or more instances in the subject disclosure, such information is referred to as report payload type III. In still another embodiment, bundling report 240 includes information that conveys a combination of (i) the number (N) of bundled data packets (or bundles); (ii) the number (M) of unbundled data packets at the mobile device; and (iii) the amount of bundled data at the mobile device. In one or more instances in the subject disclosure, such information is referred to report payload type IV. As an example, in the scenario illustrated in diagram 200, bundling of the first set of data packets leads to the second set of data packets comprising two bundled data packets 230₁ and 230₂ and two unbundled data packets 230₃ and 230₄; bundled data packets represented with a thick solid line in the diagram 200. Accordingly, N=2 and M=2. As illustrated, the first bundled data packet 230₁ includes data packets 210₁, 210₂, and 210₃, whereas the unbundled data packets 230₃ and 230₄ are the same as data packets 210₇ and 210₈, respectively. Selection of a report payload type can be static, e.g., as dictated by a standard protocol for radio telecommunication, or dynamic, as determined based at least on operation complexity or operation conditions (radio channel quality, type of data traffic, network congestion etc.).

Bundling report 240 can be delivered through the Medium Access Control (MAC) layer in the UE via a MAC control element (CE). Bundling report 240 can be embodied in a buffer status report (BSR), where the information related to the bundling of a set of data packets (e.g., data packets 210₁-210₈) is added to information related to buffer status of a buffer in the UE. Alternatively or additionally, bundling report 240 can be embodied in a new type of report, e.g., bundling report, dedicated to disclosure of information that specifies at least in part the bundling performed in the set of data packets.

The bundling report 240 can be transmitted to a serving base station (not shown) for the UE, even though the bundling report 240 can be transmitted to a base station within an active set of cells associated with the UE; such delivery can enable exploitation of the various advantages of bundling of data packets described herein after the UE is handed off the serving base station. Delivery of bundling report 240 can be accomplished through UL in the air interface. Bundling report 240 can be conveyed periodically or in accordance with a time schedule. Additionally or alternatively, bundling report 240 can be delivered in accordance with event-based delivery, e.g., the report can be conveyed in response to occurrence of a specific event. In certain embodiments, the base station to which the report is conveyed is a base station that serves the mobile device; however, the report can be conveyed to a non-serving base station that is part of an active set of base stations for the mobile device that conveys bundling report 240.

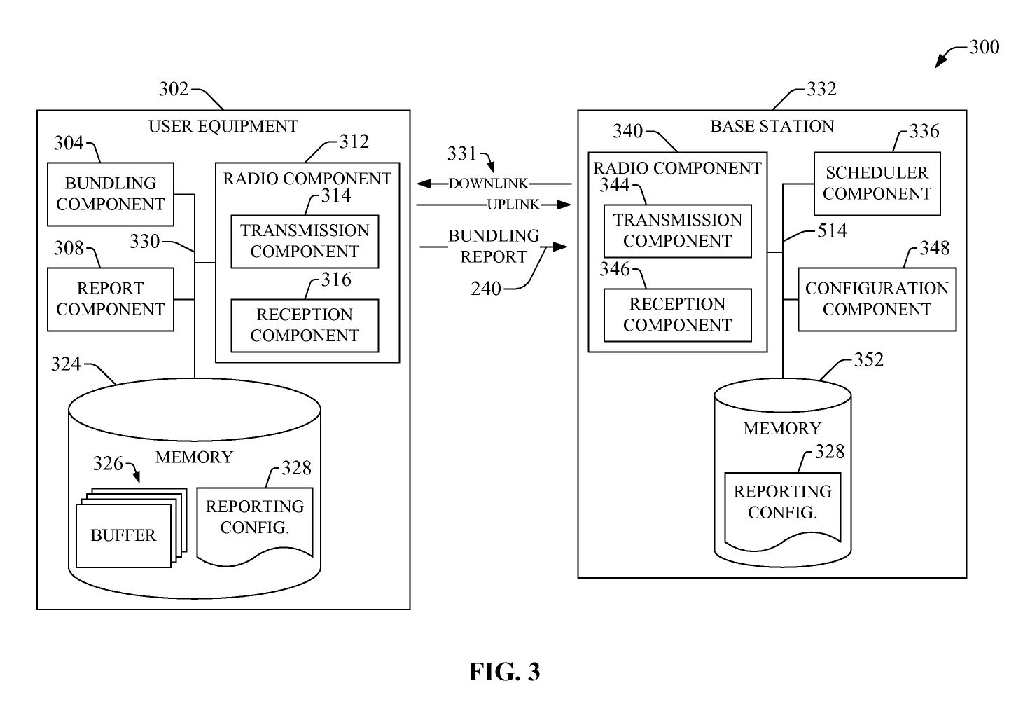

FIG. 3 presents an example system 300 that enables and exploits bundling and reporting thereof in a wireless network environment. User equipment 302 includes a bundling component 304 that performs bundling of a set of data packets at UE 302 (e.g., within buffer 326), as described supra. Based on the performed bundling, report component 308 can generate bundling report 240 in accordance with a reporting configuration 328. Report component 308 can convey the bundling report 240 to radio component 312, which can transmit, via UL in air-interface 331, the bundling report 240 to a base station. In addition, report component 308 also can convey an amount of data available for transmission per logical channel index (LCID); for example, the amount of data can be the total number of bytes available for communication in a buffer within UE 302, e.g., buffer 326. As described supra, the base station can be serving base station or a base station within an active set of cells associated with the UE. In example system 300, the bundling report 240 is delivered to base station 332. Radio component 312 can include a set of antennas and various components and related circuitry (filters, amplifiers, processors(s), modulator(s), demodulator(s), etc.) that enable wireless communication, e.g., wireless transmission and wireless reception of data and signaling. As illustrated, radio component 312 can include a transmission component 314 that can deliver the bundling report 240. Radio component 312 also can include a reception component 316 that can receive data or signaling from one or more base stations or peer devices; for example, base station 332 which can be embody a serving base station for UE 302.

Reporting configuration 328 can establish the information related to bundling to be conveyed in bundling report 240; as an example, reporting configuration 328 can determine if report payload type I, report payload type II, report payload type III, or report payload type IV is to be conveyed. Report component 308 can encode the information in a buffer status report (BSR), where the information related to the bundling of a set of data packets (e.g., data packets 210₁-210₈) is added to information related to buffer status of buffer 326 in UE 302. In certain embodiments, report component 308 can encode the information in a new type of report, e.g., bundling report, dedicated to disclosure of information that specifies at least in part the bundling performed in the set of data packets.

Additionally, reporting configuration 328 can determine a delivery mode for transmission of bundling report 240. The delivery mode can enable time-based delivery (periodic, scheduled, etc.) or event-based delivery, as described supra. In an embodiment, the delivery mode can be configured by the base station and one or more parameters that define the delivery mode can be retained in the UE, e.g., in memory 324.

Data and signaling, indications or directives, code instructions and the like are exchanged amongst bundling component 304, report component 308, radio component 312, and memory 324 through bus 330, which can be embodied in a memory bus, an address bus, a message bus, or the like.

Base station 332 can receive bundling report 240 through radio component 340, which includes a set of antennas and various components and related circuitry (filters, amplifiers, processors(s), modulator(s), demodulator(s), etc.) that enable wireless communication, e.g., wireless transmission and wireless reception of data and control. Base station 332 also can receive an amount of available data per LCID at UE 302. Radio component 340 can convey one or more of the amount of available data per LCID at UE 302 or the bundling report 240 to scheduler component 336. In response to at least one of the amount of available data per LCID at UE 302 or the bundling report 240, scheduler component 336 allocates one or more radio resources in the UL for UE 302. The radio resources comprising resource elements, physical resource blocks (PRBs), transmission time intervals (TTIs), or the like. When compared to conventional systems, at least one advantage of allocation of radio resources based in part on the bundling report 240 is knowledge of bundling structure (e.g., amount of bundled data) of buffered data at the UE without previous grant of UL radio resources; the latter, enhances scheduling processing and related grant allocation(s), and radio resource utilization in the UL.

As illustrated in example system 300, radio component 340 includes a reception component 346 that receives the bundling report 240 and the amount of available data per LCID at UE 302. Radio component 340 also includes a transmission component 344 that can deliver data or signaling to one or more mobile devices or user equipment; for example, UE 302.

Configuration component 348 can generate and deliver a reporting configuration 328. As an example, configuration component 348 can specify at least one of a time interval that defines a period of delivery of bundling report 240 or a schedule for delivery of bundling report 240; configuration component 348 can communicate, via transmission component 344, a value or other indicator of the time interval or the schedule to UE 302. As another example, configuration component 348 can establish a group of one or more events that can trigger delivery of bundling report 240 when an event in the group occurs; configuration component 348 can convey the group of one or more events to UE 302. As part of generation of the reporting configuration 328, configuration component 348 can determine a report payload type (e.g., type I, type II, type III, or type IV described supra) for the information that specifies at least in part bundling of a set of data packets (e.g., 210₁-210₈) and is conveyed in bundling report 240. In an example scenario, the group of one or more events can include events that trigger delivery of a BSR in conventional cellular wireless systems, such as change of serving base station or arrival of data traffic with higher priority than traffic queued in the buffer 326 in UE 302.

In certain embodiments, reporting configuration 328 is predetermined (e.g., standardized) and preconfigured at the time of provisioning UE 302; for example, configuration component 348 can deliver over-the-air (OTA) a reporting configuration 328 that is predetermined and that causes report component 308 to deliver report payload type III periodically, with a period substantially the same or the same as the period with which BSRs are delivered. In addition or in the alternative, reporting configuration 328 can be stored in memory 324 when UE 302 is manufactured or assembled, and can be activated at the time UE 302 is provisioned; in such scenario, reporting configuration 328 is not received OTA. In alternative or additional embodiments, UE 302 can receive from base station 332, via configuration component 348, an indication and payload data therein that defines the reporting configuration 328. Reception component 316 can receive the indication; e.g., detect the indication and decode the payload data therein. In an example, the indication can be conveyed in a MAC CE in the MAC layer of base station 332. In an aspect, UE 302 via, for example, report component 308 can negotiate (e.g., exchange signaling including queries, requests, responses, and the like) with base station 332 values of the various parameters conveyed in the indication that defines the reporting configuration 328. In certain embodiments, a dedicated component (e.g., negotiation component; not shown) in UE 302 can negotiate the reporting configuration 328.

Data and signaling, indications or directives, code instructions and the like are exchanged amongst scheduler component 336, configuration component 348, radio component 340, and memory 352 through bus 514, which can be embodied in a memory bus, an address bus, a message bus, or the like.

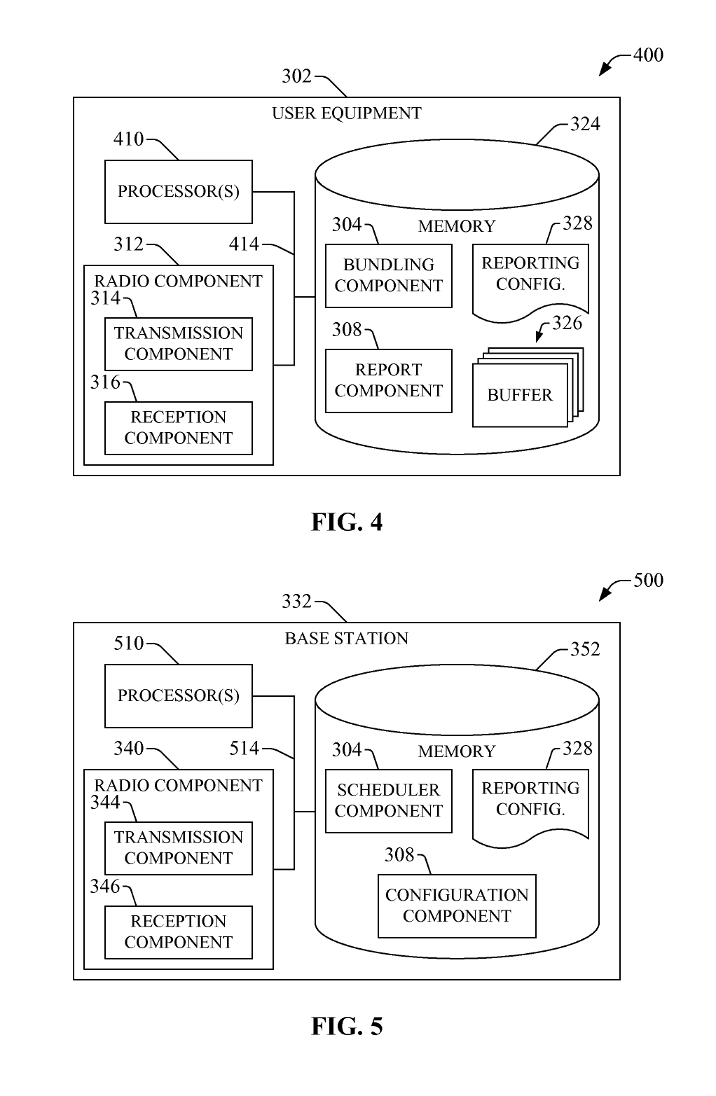

FIG. 4 presents an example embodiment 400 of a user equipment that enables and exploits bundling and reporting thereof in a wireless communication system. In example system 400, bundling component 304 and report component 308 are each embodied in one or more sets of code instructions stored, or retained, in memory 324. Processor(s) 410 can execute at least a first set of code instructions that implements the functionality of bundling component 304 in accordance with aspects described hereinabove. In addition, processor(s) 410 can execute at least a second set of code instructions that implements the functionality of report component 308 in accordance with the various aspects described supra. Thus, processor(s) 410 is configured to provide the functionality of bundling component 304 and report component 308 through execution of at least the first set of code instructions and at least the second set of code instructions.

In addition, through execution of a disparate set of code instructions retained in memory 324, processor(s) 410 is configured to operate at least in part the radio component 312, and one or more components therein, in accordance with aspects described supra. For example, processor(s) 410 is configured to transmit bundling report 240 in accordance with a reporting configuration 328; processor(s) 410 can be configured to receive the reporting configuration 328. In an aspect, in a scenario in which reporting configuration 328 establishes a group of one or more events that can trigger delivery of bundling report 240, processor(s) 410 is configured to monitor the group of one or more events and to deliver the bundling report 240 upon or after occurrence of an event in the group.

Processor(s) 410 is functionally coupled to radio component 312 and memory 324 via bus 414, which can be embodied in one or more of a memory bus, an address bus, a message bus, or the like. Data and signaling, indications or directives, code instructions and the like are exchanged amongst processor(s) 410, memory 324, and radio component 312 through bus 414.

FIG. 5 presents an example embodiment 500 of a base station that enables and exploits bundling and reporting thereof in a wireless communication system. In the subject example system, scheduler component 336 and configuration component 348 are each embodied in one or more sets of code instructions stored in memory 324. Processor(s) 510 can execute at least a first set of code instructions that implements the functionality of scheduler component 336 in accordance with aspects described hereinabove. In addition, processor(s) 510 can execute at least a second set of code instructions that implements the functionality of configuration component 148 in accordance with the various aspects described supra. Thus, processor(s) 510 is configured to provide the functionality of scheduler component 336 and configuration component 148 through execution of at least the first set of code instructions and at least the second set of code instructions.

In addition, through execution of a disparate set of code instructions retained in memory 352, processor(s) 510 is configured to operate at least in part the radio component 340, and one or more components therein, in accordance with aspects described supra. For example, in an aspect, processor(s) 510 is configured to transmit a reporting configuration 328 and various parameters related therewith. In another aspect, processor(s) 510 can be configured to receive bundling report 240; processor(s) 510 is configured to receive the bundling report 240 as dictated by a delivery mode defined by reporting configuration 328. In an aspect, in a scenario in which reporting configuration 328 establishes a group of one or more events that can trigger delivery of bundling report 240, processor(s) 410 is configured to monitor the group of one or more events and to deliver the bundling report 240 upon or after occurrence of an even in the group.

Processor(s) 510 is functionally coupled to radio component 340 and memory 352 via bus 514, which can be embodied in one or more of a memory bus, an address bus, a message bus, or the like. Data and signaling, indications or directives, code instructions and the like are exchanged amongst processor(s) 510, memory 352, and radio component 340 through bus 514.

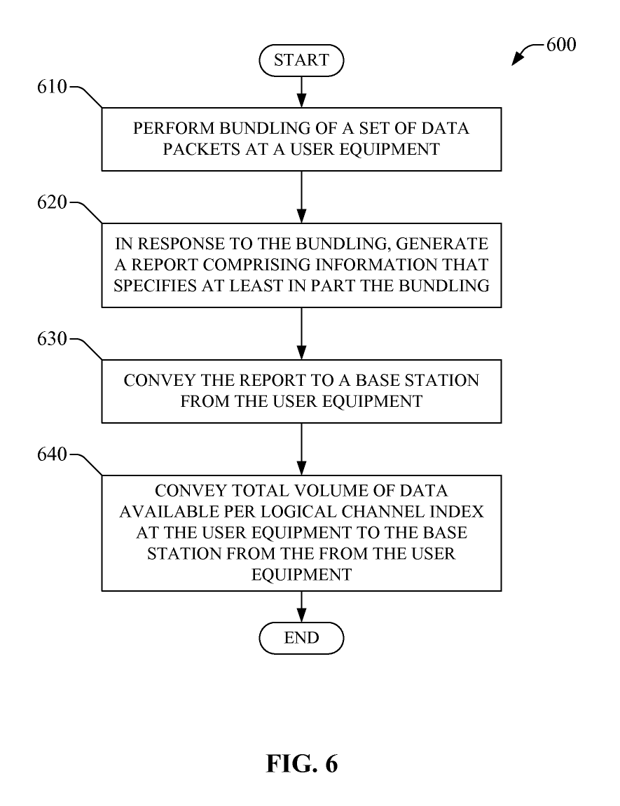

Referring to FIGS. 6-9, example methods relating to communicating characteristics of bundling of packets in a wireless communication environment are illustrated. The subject example methods are directed to bundling of data packets and reporting thereof; however, it is noted that the same or substantially the same methods can be implemented in connection with bundling of control packets and reporting thereof. While, for purposes of simplicity of explanation, the example methods are presented and described as a series of acts, it is to be understood and appreciated that the example methods are not limited by the order of acts, as some acts can, in accordance with one or more embodiments, occur in different orders or concurrently with other acts from those shown and described herein. For example, it can be understood and appreciated that an example method, or a set of one or more example methods can alternatively be represented as a series of interrelated states or events, such as in a state diagram or in a call flow. Moreover, in accordance with one or more embodiments, not all illustrated acts can be required to implement an example method or an example methodology resulting from a combination of two or more example methods described herein.

FIG. 6 presents flowchart of an example method 600 for communicating one or more characteristics of bundling of data packets in a wireless communication system. At act 610, bundling of a set of data packets at the mobile device is performed, the mobile device performing the bungling. Bundling can be performed in the PDCP layer, e.g., Service Data Units (SDUs) can be bundled to form a larger packet; see, e.g., FIG. 1. In additional or alternative embodiments, bundling can be performed in the RLC layer. At act 620, in response to performing the bundling, a report comprising information that specifies at least in part the bundling of the set the of data packets is generated; the mobile device can generate the report. As described supra, the information can be supplied in accordance with various report payload types (e.g., type I, type II, type III, or type IV): The information thus conveys at least one of (i) a number of bundled data packets; (ii) the number of bundled data packets and a number of unbundled data packets at the mobile device; or (iii) an amount of bundled data at the mobile device, the bundled data resulting from performing the bundling.

At act 630, the report (e.g., bundling report 240) is conveyed to a base station from the mobile device. Conveying the report can include delivering the report through the Medium Access Control (MAC) layer via a MAC control element (CE). In an aspect, the report can be embodied in a buffer status report (BSR), where the information related to the bundling of the set of data packets is added to information related to buffer status at the mobile device. It is noted, however, that the report can be embodied in a new type of report, e.g., bundling report, dedicated to disclosure of information that specifies at least in part the bundling performed in the set of data packets. In addition, conveying the report can include transmitting the report periodically or transmitting the report in accordance with a time schedule. Additionally or alternatively, conveying the report can include transmitting the report according to event-based delivery, as described supra. In an embodiment, the base station to which the report is conveyed can be a base station that serves the mobile device or a non-serving base station that is part of an active set of base stations for the mobile device that conveys the report.

At act 640, total volume of data available per logical channel index (ID) at the mobile deice is conveyed to the base station from the mobile device. The logical channel index (LCID) identifies one of a plurality of logical channels that can be part of the medium access control (MAC) layer in a cellular wireless system, such as a 3GPP LTE wireless network, or a 3GPP UMTS wireless network.

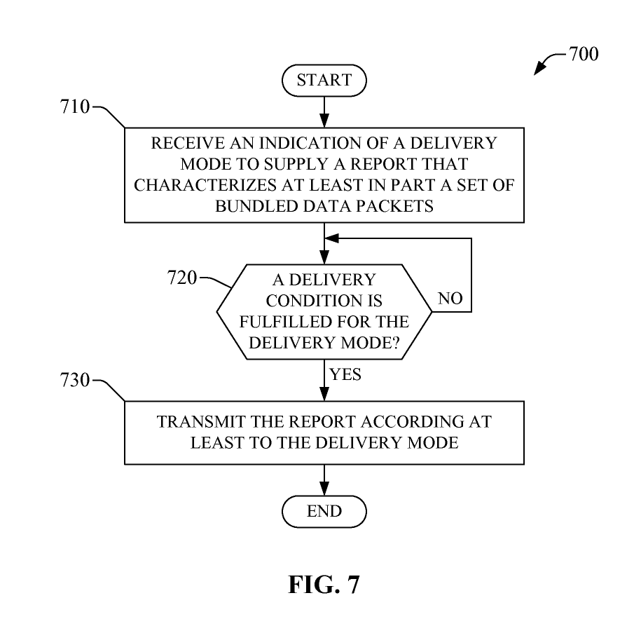

FIG. 7 presents a flowchart of an example method 700 for conveying a report that characterizes bundling of a set of data packets in a wireless communication system. In an example scenario, the subject example method can embody at least a part of act 630. At act 710, an indication of a delivery mode to supply a report (e.g., bundling report 240) comprising information that characterizes at least in part a set of bundled data packets is received from a base station. As described supra, the delivery mode can be one of time-based delivery (periodic delivery, scheduled delivery, etc.) or event-based delivery, and the base station can be a serving base station or a non-serving base station that is part of an active set of the mobile device. The delivery mode can be configured by the base station and one or more parameters that define the delivery mode can be retained in a memory within the mobile device. In a scenario, configuring the delivery mode can include negotiating with the mobile at least one of (i) one or more parameters that define the delivery mode or (ii) a report payload type (e.g., type I, type II, type III, type IV). At act 720, a determination is made to ascertain if a delivery condition for the delivery mode is fulfilled. In an aspect, the delivery mode can be an event-based delivery mode in which a group of one or more events trigger delivery of the report when at least one event in the group occurs. In such scenario, occurrence of the at least one event can be the delivery condition. In one embodiment, making the determination can include receiving a reporting configuration (e.g., 328) that defines the group of one or more events, and monitoring at least one of the one or more events; report component 308 can perform the monitoring. At act 730, when the condition is fulfilled, the report is transmitted according at least to the delivery mode.

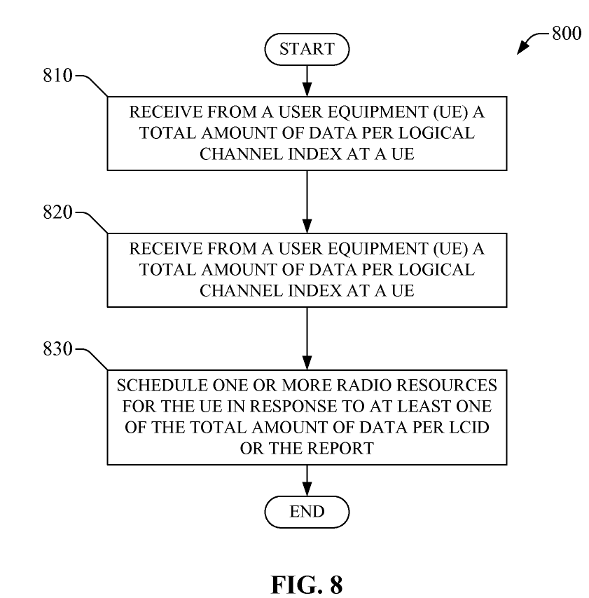

FIG. 8 is a flowchart of an example method 800 for responding to information that specifies bundling of data packets in a wireless communication system. In an aspect, the subject example method is conducted by a base station that serves a UE that performs the bundling. At act 810, a total amount of data per logical channel index (LCID) available at the UE is received from the UE. At act 820, a report that specifies at least in part bundling of a set of data packets is received from the UE that performs the bundling. At act 830, one or more radio resources (resource elements, physical resource blocks (PRBs), transmission time intervals (TTIs), etc.) are scheduled for the UE in response to at least one of the total amount of data per LCID or the report. The scheduling is effected by the base station that serves the mobile device that performs the bundling. In an aspect, uplink (UL) radio resources can be utilized more efficiently by exploiting the information included in the report.

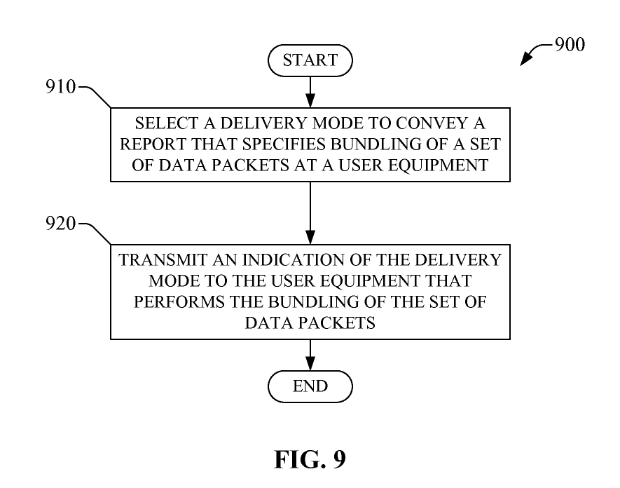

FIG. 9 is a flowchart of an example method 900 for configuring a delivery mode to provide a report comprising information that specifies bundling of a set of data packets in a wireless communication system. At act 910, a delivery mode is selected to convey a report that specifies bundling of a set of data packets at a user equipment (e.g., UE 302), the bundling performed by the user equipment. In an embodiment, selecting the delivery mode can include specifying a time interval that defines a period of delivery of the report. In an aspect, the time interval can be the same or substantially the same as the time interval for delivery of a buffer status report in the user equipment. In another aspect, the time interval can be commensurate with the time interval for delivery of the buffer status report in the user equipment. In another embodiment, selecting the delivery mode includes defining a schedule for delivery of the report; as an example, the schedule can be based on historical data on data traffic in a cell served by the base station that serves the user equipment. In yet another embodiment, selecting the delivery mode includes configuring a set of one or more events that, when an event in the set occurs, trigger delivery of the report. Moreover, in certain embodiments, selecting a delivery mode can include negotiating with a UE a set of parameters and report payload type that specify, at least in part, the delivery mode. In an aspect, a component in a base station (e.g., a negotiation component (not shown)) can conduct at least part of the negotiating. At act 920, an indication of the delivery mode is transmitted to the user equipment that performs the bundling of the set of data packets. The indication can be delivered in a downlink (DL) control channel.

It will be appreciated that, in accordance with one or more aspects described herein, inferences can be made pertaining to performing bundling of data packets available at a UE for transmission, and reporting the bundling in a wireless communication environment. As an example, an inference can be made with directed to determining delivery mode or report payload type that are cost-effective with respect to operation complexity and operation conditions (radio channel quality, type of data traffic, network congestion etc.). As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

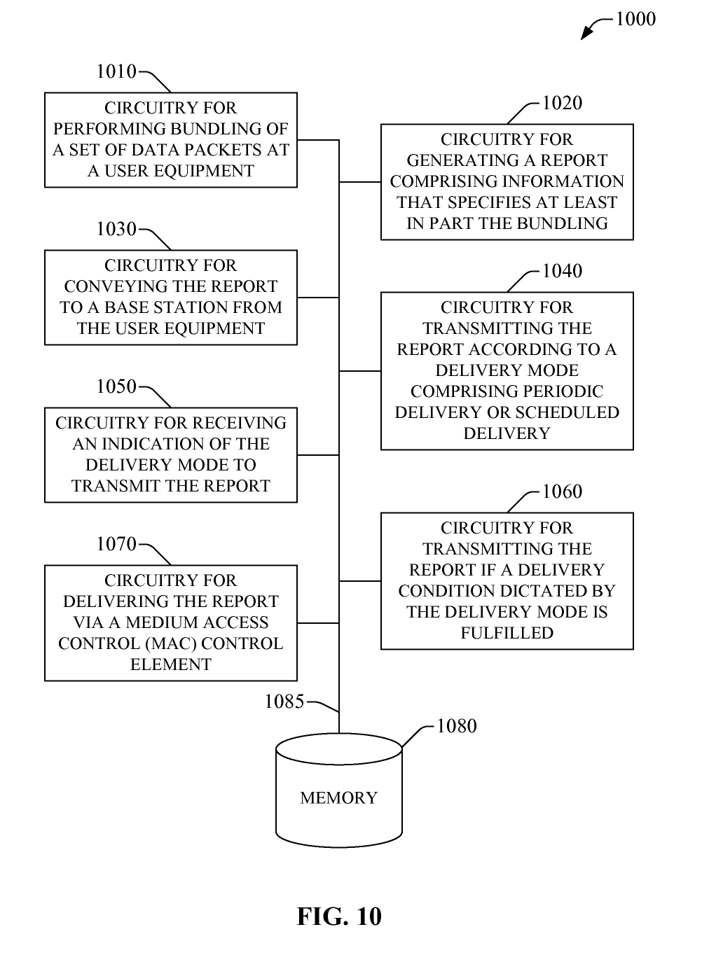

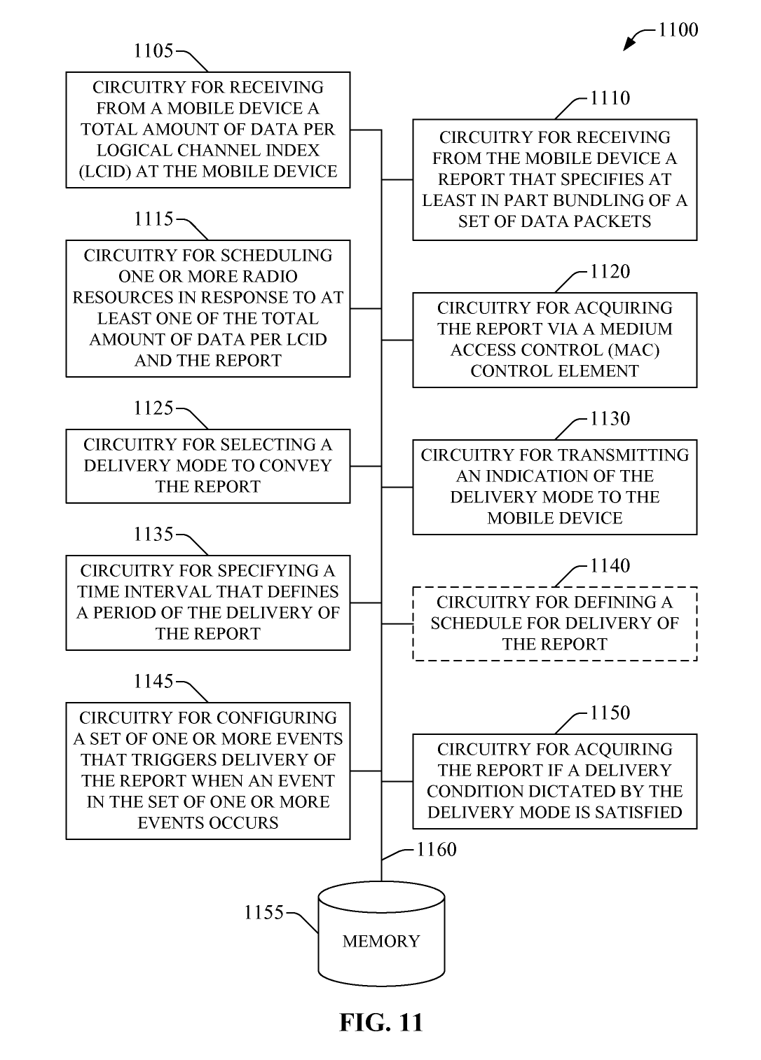

FIGS. 10-11 illustrate example systems 1000 and 1100, respectively, that enable bundling of data packets and reporting thereof in a wireless communication system. In an aspect, example system 1000 can reside at least in part within a user equipment. It is to be appreciated that system 1000 is represented as including functional blocks, or electronic circuitry, which can be functional blocks that represent functions implemented by a processor, software, or combination thereof (e.g., firmware). As illustrated, example system 1000 includes electronic circuitry (also referred to as circuitry) 1010 for performing bundling of a set of data packets at a user equipment; circuitry 1020 for generating a report comprising information that specifies at least in part the bundling; and circuitry 1030 for conveying the report to a base station from the user equipment. In addition, example system 1000 includes circuitry 1040 for transmitting the report according to a delivery mode comprising periodic delivery or scheduled delivery, wherein the information conveys at least one of (A) a number of bundled data packets; (B) a number of unbundled data packets at the user equipment; or (C) an amount of bundled data at the user equipment, the bundled data resulting from performing the bundling. Moreover, example system 1000 includes circuitry 1050 for receiving from the base station an indication of the delivery mode to transmit the report, wherein the base station is one of a serving base station for the user equipment or a non-serving base station in an active set for the user equipment. Furthermore, example system includes circuitry 1060 for transmitting the report if a delivery condition dictated by the delivery mode is fulfilled. Example system 1000 also can include circuitry 1070 for delivering the report via a medium access control (MAC) control element; in an aspect, the report is a buffer status report (BSR) and the information that specifies at least in part the bundling is added to information related to buffer status at the user equipment.

The example system 1000 also includes a memory 1080 that can retain one or more sets of code instructions that, when executed by at least one processor (not shown), which can be part of the described circuitry, implement or enable the functionality of the circuitry that is part of example system 1000 in accordance with aspects or features described herein in connection with information that specifies bundling of data packets and response to the bundling in a wireless communication environment. In certain embodiments, the at least one processor (not shown) can be distributed amongst the circuitry that is part of example system 1000. In alternative or additional embodiments, the at least one processor can be centralized within example system 1000. The one or more sets of code instructions retained in memory 1080 thus enable executing functions associated with circuitry. While shown as being external to memory 1080, it is to be understood that one or more of circuitry 1010, 1020, 1030, 1040, 1050, 1060, or 1070 can reside within the memory 1080. Memory 1080 also can retain a reporting configuration (e.g., 328) that conveys a mode of delivery for a bundling report (e.g., 240), as described supra.

Interface 1085 enables exchange of data (e.g., code instructions, parameters . . . ) amongst the various circuitry of example system 1000. To at least such end, the interface 1085 can include various architectures such as memory bus(es), address bus(es), message bus(es), wired or wireless links, or the like.

Various embodiments of example system 1000 can be attained through one or more structural variations thereof, where one or more of circuitry 1010, 1020, 1030, 1040, 1050, 1060, or 1070 are combined into different circuitry. As an example, circuitry 1040 can be combined with circuitry 1030 for conveying the report to a base station from the UE. As another example, circuitry 1070 can be combined with circuitry 1060 for transmitting the report via a MAC control element if the delivery condition dictated by the delivery mode is fulfilled.

Example system 1100 can reside at least in part within a base station (e.g., 332). It is to be appreciated that system 1100 is represented as including functional blocks, or electronic circuitry, which can be functional blocks that represent functions implemented by a processor, software, or combination thereof (e.g., firmware). As illustrated, example system 1100 includes electronic circuitry (also referred to as circuitry) 1105 for receiving from a mobile device a total amount of data per logical channel index (LCID) at the mobile device; circuitry 1110 for receiving from the mobile device a report that specifies at least in part bundling of a set of data packets; and circuitry 1115 scheduling one or more radio resources in response to at least one of the total amount of data per LCID and the report.

In addition, example system 1100 includes circuitry 1120 for acquiring the report via a medium access control (MAC) control element. Moreover, example system 1100 includes circuitry 1125 for selecting a delivery mode to convey the report; and circuitry 1130 for transmitting an indication of the delivery mode to the mobile device. Furthermore, example system 1100 includes circuitry 1135 for specifying a time interval that defines a period of delivery of the report or, alternatively, circuitry 1140 for defining a schedule for delivery of the report. Further yet, example system 1100 includes circuitry 1145 for configuring a set of one or more events that triggers delivery of the report when an event in the set of one or more events occurs. In additional or alternative embodiments, circuitry 1135, circuitry 1140, and circuitry 1145 can be combined to form circuitry for negotiating a delivery mode with a UE. Example system 1100 also includes circuitry 1150 for acquiring the report if a delivery condition dictated by the delivery mode is satisfied.

The example system 1100 also includes a memory 1155 that can retain one or more sets of code instructions that, when executed by at least one processor (not shown), which can be part of the described circuitry, implement or enable the functionality of the circuitry that is part of example system 1100 in accordance with aspects or features described herein in connection with information that specifies bundling of data packets and response to the bundling in a wireless communication environment. In certain embodiments, the at least one processor (not shown) can be distributed amongst the circuitry that is part of example system 1100. In alternative or additional embodiments, the at least one processor can be centralized within example system 1100. The one or more sets of code instructions retained in memory 1155 thus enable executing functions associated with circuitry. While shown as being external to memory 1155, it is to be understood that one or more of circuitry 1105, 1110, 1115, 1120, 1125, 1130, 1135, 1140, 1145, or 1150 can reside within the memory 1155. Memory 1155 also can retain one or more parameters that define a reporting configuration or associated delivery modes for a bundling report (e.g., 240), as described supra.

Interface 1160 enables exchange of data (e.g., code instructions, parameters . . . ) amongst the various circuitry of example system 1100. To at least such end, the interface 1160 can include various architectures such as memory bus(es), address bus(es), message bus(es), wired or wireless links, or the like.

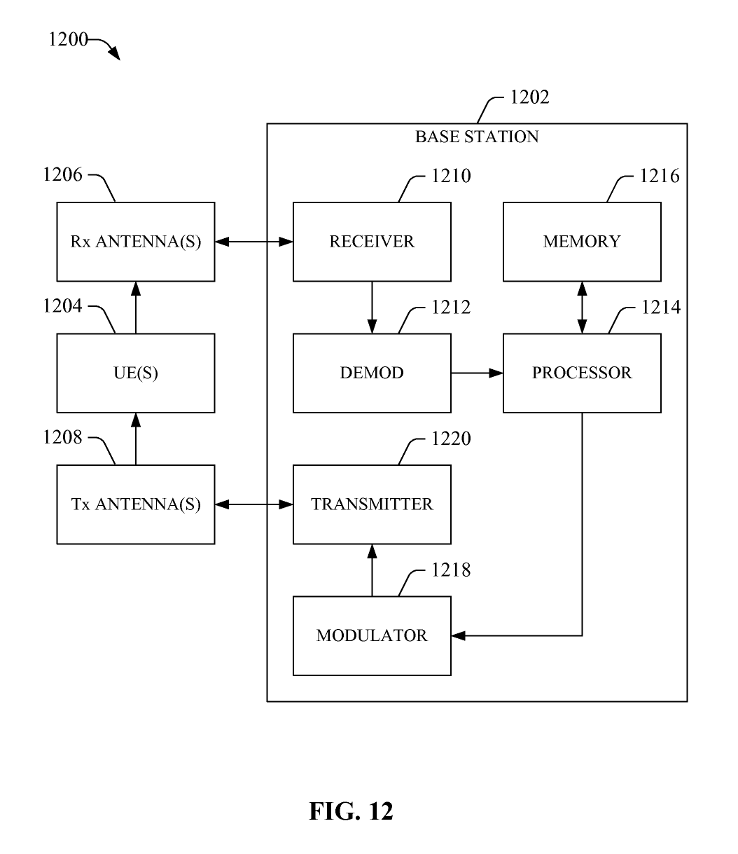

FIG. 12 illustrates an example system 1200 that can be utilized to implement various aspects of the functionality described herein. System 1200 can include a base station 1202 (e.g., base station 332 . . . ). Base station 1202 can receive signal(s) from one or more UEs 1204 via one or more receive (Rx) antennas 1206 and transmit to the one or more UEs 1204 via one or more transmit (Tx) antennas 1208. Further, base station 1202 can include a receiver 1210 that receives information from receive antenna(s) 1206. According to an example, receiver 1210 can be operatively associated with a demodulator (demod) 1212 that demodulates received information. Demodulated symbols can be analyzed by a processor 1214. Processor 1214 can be coupled to memory 1216, which can store, or retain, data to be transmitted to or received from UE(s) 1204 and/or any other suitable protocols, algorithms, information, etc. related to performing the various actions and functions set forth herein. For example, base station 1202 can employ processor 1214 to perform example method 800, example method 900, and/or other similar and suitable example methods. Base station 1202 can further include a modulator 1218 that can multiplex a signal for transmission by a transmitter 1220 through antenna(s) 1208.

Processor 1214 can be a processor dedicated to analyzing information received by receiver 1210, dedicated to generating information for transmission by transmitter 1220, or dedicated to controlling one or more components of base station 1202. According to another example, processor 1214 can analyze information received by receiver 1210, generate information for transmission by transmitter 1220, and control one or more components of base station 1202. The one or more components of base station 1202 can include, for example, scheduler component 336, configuration component 348, reception component 346, and/or transmission component 344. Moreover, although not shown, it is contemplated that the one or more components of base station 1202 can be part of processor 1214 (see, e.g., FIG. 5) or a plurality of processors within base station 1202.

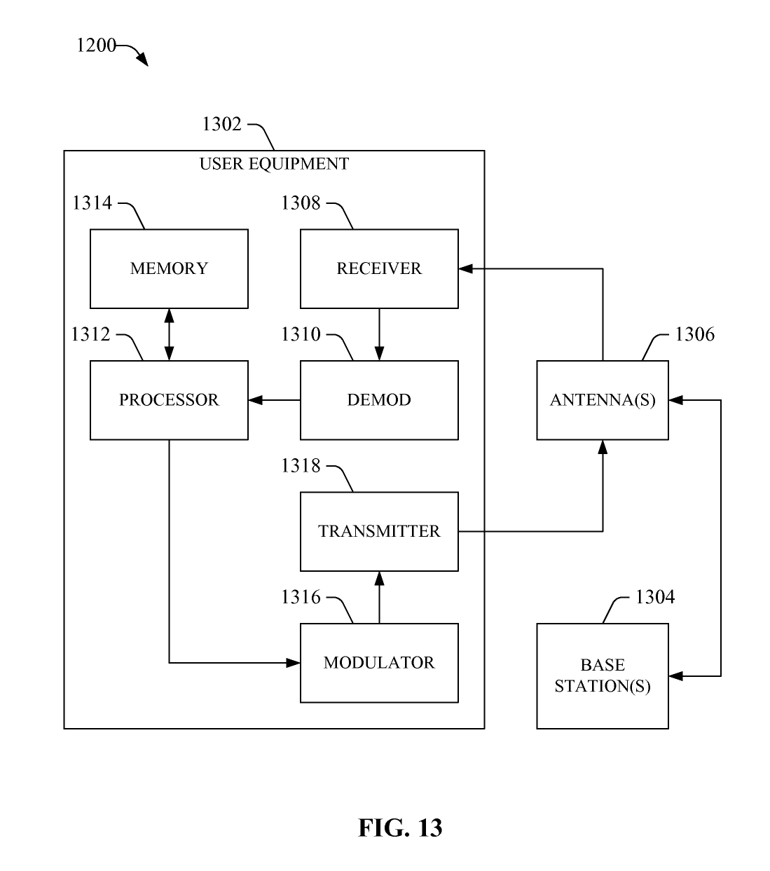

FIG. 13 illustrates an example system 1300 that can be utilized to implement various aspects of the functionality described herein. System 1300 can include a UE 1302 (e.g., UE 302). UE 1302 can receive signal(s) from one or more base stations 1304 and/or transmit to one or more base stations 1304 via one or more antennas 1306. Further, UE 1302 can include a receiver 1308 that receives information from antenna(s) 1306. According to an example, receiver 1308 can be operatively associated with a demodulator (demod) 1310 that demodulates received information. Demodulated symbols can be analyzed by a processor 1312. Processor 1312 can be coupled to memory 1314, which can store data to be transmitted to or received from base station(s) 1304 and/or any other suitable protocols, algorithms, information, etc. related to performing the various actions and functions set forth herein. For example, UE 1302 can employ processor 1312 to perform example method 600, 700, and/or other similar and suitable methods for performing bundling of data packets and reporting thereof. UE 1302 can further include a modulator 1316 that can multiplex a signal for transmission by a transmitter 1318 through antenna(s) 1306.

Processor 1312 can be a processor dedicated to analyzing information received by receiver 1308, dedicated to generating information for transmission by transmitter 1318, or dedicated to controlling one or more components of UE 1302. According to another example, processor 1312 can analyze information received by receiver 1308, generate information for transmission by transmitter 1318, and control one or more components of UE 1302. The one or more components of UE 1302 can include, for example, bundling component 304, report component 308, transmission component, 314 and/or reception component 316. Moreover, although not shown, it is contemplated that the one or more components of UE 1302 can be part of processor 1312 (see, e.g., FIG. 4) or a plurality of processors (not shown).

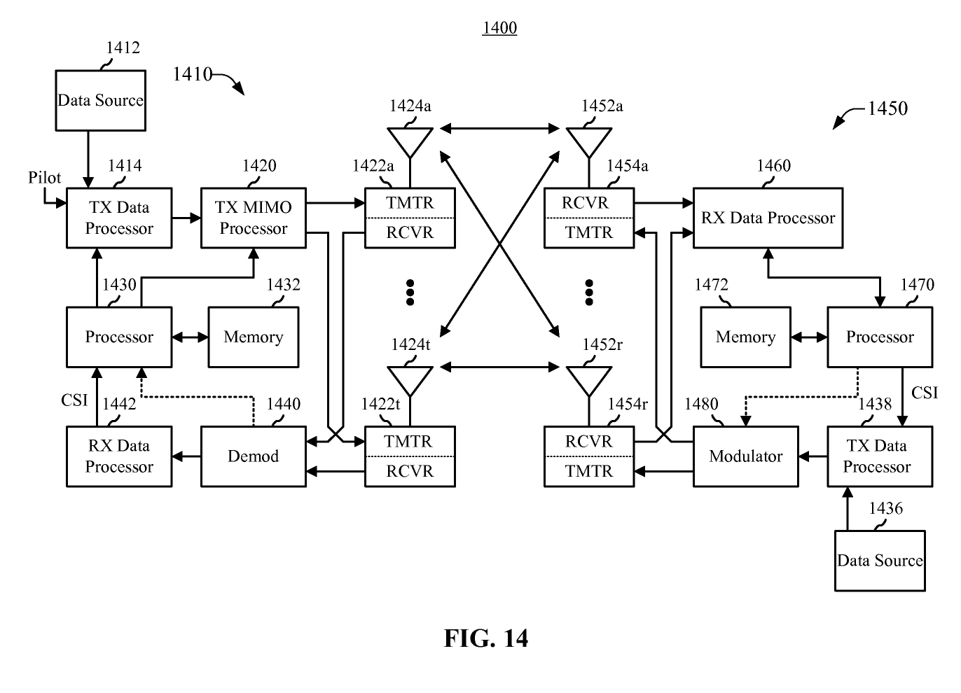

FIG. 14 presents an example wireless communication system 1400. Example wireless communication system 1400 depicts one base station 1410 and one UE 1450 for sake of brevity. However, it is to be appreciated that example wireless communication system 1400 can include more than one base station and/or more than one UE, wherein additional base stations and/or UEs can be substantially similar or different from example base station 1410 and UE 1450 described below. In addition, it is to be appreciated that base station 1410 and/or UE 1450 can employ the systems (e.g., FIGS. 1, 3-5 and 10-13) and/or methods (FIGS. 6-9) described herein to enable wireless communication there between.

At base station 1410, traffic data for a number of data streams is provided from a data source 1412 to a transmit (TX) data processor 1414. According to an example, each data stream can be transmitted over a respective antenna. TX data processor 1414 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at UE 1450 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1430.

The modulation symbols for the data streams can be provided to a TX MIMO processor 1420, which can further process the modulation symbols (e.g., for OFDM). TX MIMO processor 1420 then provides N_{T} modulation symbol streams to N_{T} transmitters (TMTR) 1422a through 1422t. In various embodiments, TX MIMO processor 1420 applies beamforming weights to the symbols of the data streams and to the antenna from which the symbol is being transmitted.

Each transmitter 1422 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1422a through 1422t are transmitted from N_{T} antennas 1424a through 1424t, respectively.

At UE 1450, the transmitted modulated signals are received by N_{R} antennas 1452a through 1452r and the received signal from each antenna in the group of antennas 1452a-1452r is provided to a respective receiver (RCVR) 1454a through 1454r. Each receiver 1454 conditions (e.g., filters, amplifies, and downconverts) a respective signal, digitizes the conditioned signal to provide samples, and further processes the samples to provide a corresponding “received” symbol stream.

An RX data processor 1460 can receive and process the N_{R} received symbol streams from N_{R} receivers 1454 based on a particular receiver processing technique to provide N_{T} “detected” symbol streams. RX data processor 1460 can demodulate, deinterleave, and decode each detected symbol stream to recover the traffic data for the data stream. The processing by RX data processor 1460 is complementary to that performed by TX MIMO processor 1420 and TX data processor 1414 at base station 1410.

A processor 1470 can periodically determine which available technology to utilize as discussed above. Further, processor 1470 can formulate an uplink message comprising a matrix index portion and a rank value portion.

The uplink message can comprise various types of information regarding the telecommunication link and/or the received data stream. The uplink message can be processed by a TX data processor 1438, which also receives traffic data for a number of data streams from a data source 1436, modulated by a modulator 1480, conditioned by transmitters 1454a through 1454r, and transmitted back to base station 1410.

At base station 1410, the modulated signals from UE 1450 are received by antennas 1424, conditioned by receivers 1422, demodulated by a demodulator 1440, and processed by a RX data processor 1442 to extract the uplink message transmitted by UE 1450. Further, processor 1430 can process the extracted message to determine which precoding matrix to use for determining the beamforming weights.

Processors 1430 and 1470 can direct (e.g., control, coordinate, manage, etc.) operation at base station 1410 and UE 1450, respectively. Respective processors 1430 and 1470 can be associated with memory 1432 and 1472 that store program codes and data. Processors 1430 and 1470 can also perform computations to derive frequency and impulse response estimates for the uplink and downlink, respectively.

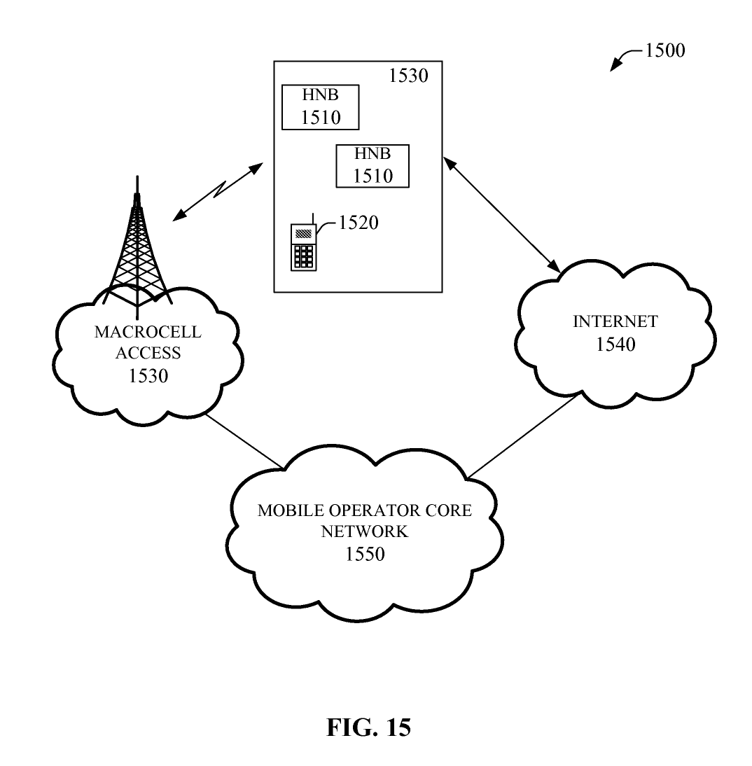

FIG. 15 illustrates an example wireless communication system to also can implement or exploit various aspects of the subject disclosure. As shown in FIG. 15, the system 1500 includes multiple access point base stations or, in the alternative, femto cells, Home Node B units (HNBs), or Home evolved Node B units (HeNBs), such as, for example, HNBs 1510, each being installed in a corresponding small scale network environment, such as, for example, in one or more user residences 1530, and being configured to serve associated, as well as alien, user equipment (UE) or mobile stations 1520. Each HNB 1510 is further coupled to the Internet 1540 and a mobile operator core network 1550 via a DSL router (not shown) or, alternatively, a cable modem (not shown).

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It is to be understood that the aspects described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable storage medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored, or retained, in memory units and executed by processors. The memory unit can be implemented within the processor or external to the processor, in which case it can be communicatively coupled to the processor via various means as is known in the art.

The steps or acts of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

What has been described above includes examples of one or more embodiments. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
performing bundling of a set of data packets at a user equipment;
generating a report comprising information that specifies at least in part the bundling in response to performing the bundling; and
conveying the report to a base station from the user equipment.

2. The method of claim 1, wherein the conveying comprises:
transmitting the report according to a delivery mode comprising periodic delivery or scheduled delivery, wherein the information conveys at least one of (i) a number of bundled data packets at the user equipment or (ii) an amount of bundled data at the user equipment, the bundled data resulting from performing the bundling.

3. The method of claim 2, wherein the conveying further comprises:
receiving from the base station an indication of the delivery mode to transmit the report, wherein the base station is one of a serving base station for the user equipment or a non-serving base station in an active set for the user equipment.

4. The method of claim 2, wherein the conveying further comprises:
transmitting the report if a delivery condition in an event-based delivery mode is fulfilled.

5. The method of claim 2, wherein transmitting the report includes delivering the report via a medium access control (MAC) control element.

6. The method of claim 5, wherein the report is a buffer status report (BSR), the information that specifies at least in part the bundling is added to information related to buffer status at the user equipment.

7. An apparatus, comprising:
at least a memory that retains instructions related to performing bundling of a set of data packets at a user equipment, generating a report comprising information that specifies at least in part the bundling in response to performing the bundling, and conveying the report to a base station from the user equipment; and
at least a processor functionally coupled to at least the memory and configured to execute the instructions retained in at least the memory.

8. The apparatus of claim 7, wherein the instructions related to the conveying include instructions related to transmitting the report according to a delivery mode comprising periodic delivery or scheduled delivery, wherein the information conveys at least one of (i) a number of bundled data packets at the user equipment or (ii) an amount of bundled data at the user equipment, the bundled data resulting from performing the bundling.

9. The apparatus of claim 8, wherein the instructions related to the conveying further include instructions related to receiving from the base station an indication of the delivery mode to transmit the report, wherein the base station is one of a serving base station for the user equipment or a non-serving base station in an active set for the user equipment.

10. The apparatus of claim 8, wherein the instructions related to the conveying include instructions related to transmitting the report if a delivery condition in an event-based delivery mode is fulfilled.

11. The apparatus of claim 8, wherein the instructions related to transmitting the report include instructions related to delivering the report via a medium access control (MAC) control element.

12. The apparatus of claim 11, wherein the report is a buffer status report (BSR), the information that specifies at least in part the bundling is added to information related to buffer status at the user equipment.

13. A wireless communication apparatus, comprising:
means for performing bundling of a set of data packets at a user equipment;
means for generating a report comprising information that specifies at least in part the bundling in response to performing the bundling; and
means for conveying the report to a base station from the user equipment.

14. The wireless communication apparatus of claim 13, wherein the means for conveying includes means for transmitting the report according to a delivery mode comprising periodic delivery or scheduled delivery, wherein the information conveys at least one of (A) a number of bundled data packets at the user equipment or (B) an amount of bundled data at the user equipment, the bundled data resulting from performing the bundling.

15. The wireless communication apparatus of claim 14, wherein the means for conveying further includes means for receiving from the base station an indication of the delivery mode to transmit the report, wherein the base station is one of a serving base station for the user equipment or a non-serving base station in an active set for the user equipment.

16. The wireless communication apparatus of claim 14, wherein the means for conveying further includes means for delivering the report if a delivery condition in an event-based delivery mode is fulfilled.

17. The wireless communication apparatus of claim 14, wherein the means for transmitting the report includes means for delivering the report via a medium access control (MAC) control element, the report is a buffer status report (BSR) and the information that specifies at least in part the bundling is added to information related to buffer status at the user equipment.

18. A computer program product, comprising:
a computer-readable medium, comprising:
code for causing at least one computer to perform bundling of a set of data packets at a user equipment;
code for causing the at least one computer to generate a report comprising information that specifies at least in part the bundling in response to performing the bundling; and
code for causing the at least one computer to convey the report to a base station from the user equipment.

19. The computer program product of claim 18, wherein the computer-readable medium further comprises code for causing the at least one computer to transmit the report according to a delivery mode comprising periodic delivery or scheduled delivery, the information conveys at least one of (I) a number of bundled data packets at the user equipment or (II) an amount of bundled data at the user equipment, the bundled data resulting from performing the bundling.

20. The computer program product of claim 19, wherein the computer-readable medium further comprises code for causing the at least one computer to receive from the base station an indication of the delivery mode to transmit the report, wherein the base station is one of a serving base station for the user equipment or a non-serving base station in an active set for the user equipment.

21. The computer program product of claim 19, wherein the computer-readable medium further comprises code for causing the at least one computer to transmit the report if a delivery condition in an event-based delivery mode is fulfilled.

22. The computer program product of claim 19, wherein the computer-readable medium further comprises code for causing the at least one computer to deliver the report via a medium access control (MAC) control element, the report is a buffer status report (BSR) and the information that specifies at least in part the bundling is added to information related to buffer status at the user equipment.

23. A wireless communication apparatus, comprising:
at least a processor configured to:
perform bundling of a set of data packets at a user equipment;
generate a report comprising information that specifies at least in part the bundling in response to performing the bundling, the information conveys at least one of a number of bundled data packets at the user equipment; an amount of bundled data at the user equipment, the bundled data resulting from performing the bundling; or a combination thereof; and
transmit the report to a base station from the user equipment.

24. A method, comprising:
receiving from a mobile device a total amount of data per logical channel index (LCID) at the mobile device;
receiving from the mobile device a report that specifies at least in part bundling of a set of data packets, the mobile device performing the bundling; and
scheduling one or more radio resources in response to at least one of the total amount of data per LCID and the report.

25. The method of claim 24, wherein the receiving includes acquiring the report via a medium access control (MAC) control element.

26. The method of claim 24, further comprising:
selecting a delivery mode to convey the report; and
transmitting an indication of the delivery mode to the mobile device.

27. The method of claim 26, wherein selecting the delivery mode includes:
specifying a time interval that defines a period of delivery of the report; or
defining a schedule for delivery of the report.

28. The method of claim 26, wherein selecting the delivery mode includes configuring a set of one or more events that triggers delivery of the report when an event in the set of one or more events occurs.

29. The method of claim 26, wherein the receiving includes acquiring the report if a delivery condition in an event-based delivery mode is satisfied.

30. An apparatus, comprising:
at least a memory that retains instructions related to receiving from a mobile device a report that specifies at least in part bundling of a set of data packets, the mobile device performing the bundling, and scheduling one or more radio resources in response to at least the report; and
at least a processor functionally coupled to at least the memory and configured to execute the instructions retained in at least the memory.

31. The apparatus of claim 30, wherein the instructions related to the receiving include instructions related to acquiring the report via a medium access control (MAC) control element.

32. The apparatus of claim 30, wherein the memory further retains instructions related to selecting a delivery mode to convey the report, and transmitting an indication of the delivery mode to the mobile device.

33. The apparatus of claim 32, wherein the instructions related to selecting the delivery mode include instructions related to specifying a time interval that defines a period of delivery of the report, or instructions related to defining a schedule for delivery of the report.

34. The apparatus of claim 32, wherein the instructions related to selecting the delivery mode include instructions related to configuring a set of one or more events that triggers delivery of the report when an event in the set of one or more events occurs.

35. The apparatus of claim 32, wherein the instructions related to the receiving further include instructions related to acquiring the report if a delivery condition in an event-based delivery mode is satisfied.

36. A wireless communication apparatus, comprising:
means for receiving from a mobile device a total amount of data per logical channel index (LCID) at the mobile device;
means for receiving from the mobile device a report that specifies at least in part bundling of a set of data packets; and
means for scheduling one or more radio resources in response to at least one of the total amount of data per LCID and the report.

37. The wireless communication apparatus of claim 36, wherein the means for receiving includes means for acquiring the report via a medium access control (MAC) control element.

38. The wireless communication apparatus of claim 36, further comprising:
means for selecting a delivery mode to convey the report; and
means for transmitting an indication of the delivery mode to the mobile device.

39. The wireless communication apparatus of claim 38, wherein the means for selecting the delivery mode includes:
means for specifying a time interval that defines a period of delivery of the report; or;
means for defining a schedule for delivery of the report.

40. The wireless communication apparatus of claim 38, wherein the means for selecting the delivery mode includes means for configuring a set of one or more events that triggers delivery of the report when an event in the set of one or more events occurs.

41. The wireless communication apparatus of claim 38, wherein the means for receiving includes means for acquiring the report if a delivery condition in an event-based delivery mode is satisfied.

42. A computer program product, comprising:
a computer-readable medium, comprising:
code for causing at least one computer to receive from a mobile device a report that specifies at least in part bundling of a set of data packets performed at the mobile device; and
code for causing the at least one computer to schedule one or more radio resources in response to at least on the report.

43. The computer program product of claim 42, wherein the computer-readable medium further comprises code for causing the at least one computer to acquire the report via a medium access control (MAC) control element.

44. The computer program product of claim 42, wherein the computer-readable medium further comprises:
code for causing the at least one computer to select a delivery mode to convey the report; and
code for causing the at least one computer to transmit an indication of the delivery mode to the mobile device.

45. The computer program product of claim 44, wherein the computer-readable medium further comprises:
code for causing the at least one computer to specify a time interval that defines a period of delivery of the report; or
code for causing the at least one computer to define a schedule for delivery of the report.

46. The computer program product of claim 44, wherein the computer-readable medium further comprises code for causing the at least one computer to configure a set of one or more events that triggers delivery of the report when an event in the set of one or more events occurs.

47. The computer program product of claim 44, wherein the computer-readable storage medium further comprises code for causing the at least one computer to acquire the report if a delivery condition in an event-based delivery mode is satisfied.

48. A wireless communication apparatus, comprising:
at least a processor configured to:
receive from a mobile device a total amount of data per logical channel index (LCID) at the mobile device;
receive from the mobile device a report that specifies at least in part bundling of a set of data packets, the mobile device performing the bundling; and
schedule one or more radio resources in response to at least one of the total amount of data per LCID and the report.
